(19) United States
(12) Patent Application Publication
(10) Pub. No.: US 2026/0117679 A1
(43) Pub. Date: Apr. 30, 2026

(54) SEPARATION TOOL FOR COMPONENT SEGMENT OF TURBINE SYSTEM

(71) Applicant: GE Vernova Infrastructure Technology LLC, Greenville, SC (US)

(72) Inventors: Marek MACHOWSKI, Masovian (PL); Lukasz SAJDAK, Masovian (PL); Mateusz KORUS, Masovian (PL)

(21) Appl. No.: 19/368,632

(22) Filed: Oct. 24, 2025

(30) Foreign Application Priority Data
Oct. 31, 2024 (EP) 24461632.2

(51) Int. Cl. F01D 25/24

(52) U.S. Cl. CPC F01D 25/24; F05D 2230/80

(57) ABSTRACT

A tool for separating adjacent component segments in a stage of a turbine section. The tool includes a base and first and second curved plates. The first plate includes a first end to engage a portion of a component segment, and the second plate includes a first end to engage a fixed element, such as the other component segment or a half casing of the turbine section. A coupler couples the first plate to the base, and a linear actuator is between the base and the second plate. The linear actuator linearly moves the second plate between a first position in which the first ends of the first and second plates are retracted and a second position in which the first ends of the first and second plates are extended a distance from one another to force the adjacent component segments to separate.

### CROSS-REFERENCE TO RELATED APPLICATION

This application claims priority pursuant to 35 U.S.C. 119(a) to European Application No. 24461632.2, filed Oct. 31, 2024, which application is incorporated herein by reference in its entirety.

### TECHNICAL FIELD

The disclosure relates generally to turbine systems and, more particularly, to a separation tool to separate adjacent component segments, such as nozzle segments, in preparation for removing the segments from the casing of the turbine section for repair or replacement.

### BACKGROUND

A turbine system extracts energy from a flow of a working fluid, e.g., hot combustion gases, steam, water, etc., for producing output power for an external load such as an electrical generator and the like. In one example, a gas turbine (GT) system extracts energy from the flow of hot combustion gases. The GT system includes a compressor for compressing ambient air and a combustor for mixing the flow of air with a flow of fuel to generate hot combustion gases. A turbine section (e.g., an expansion turbine) receives the flow of hot combustion gases and extracts energy therefrom for powering the compressor and for producing output power for the external load. The hot gas components such as the turbine nozzles and blades positioned along the hot gas path of a GT system are subject to not only high temperatures and pressures but also different types of dynamic forces. Other turbine systems, e.g., steam or water turbines, experience similar environmental conditions on their working fluid components. Given such environments, these components may be replaced and/or refurbished on a periodic basis to ensure efficient and safe performance of the turbine system.

Removal of a component such as a nozzle and the like may be difficult and time consuming. Each stage of the components in a turbine section typically may be formed in segments that are placed circumferentially end-to-end to form a continuous ring within a half casing of the turbine section. The extreme environments, such as high temperature and high-pressure, may cause the component segments to stick together and/or to be seized in the supporting structure. The small clearances in the turbine section, e.g., such as between a radial outer end of nozzle segments and insulation within a half casing of the turbine section, provide very little space to access the component segments or to apply any type of force to separate the component segments prior to removal. One approach to separating the component segments applies a force to the more readily accessible parts, such as airfoils, of the component segments. However, this approach increases the probability of damaging the re-usable and perhaps more sensitive parts, such as airfoils of a nozzle segment. Another approach uses a tool between the casing and one of the component segments to apply a force to remove the component segments, but this approach requires access from outside the casing and two operators—one person in the casing and one outside the casing—to properly use.

### SUMMARY

All aspects, examples and features mentioned below can be combined in any technically possible way.

An aspect of the disclosure provides a tool for separating a first component segment from a second component segment adjacent the first component segment in a stage of a turbine section, the tool comprising: a base; a first curved plate including a first end configured to engage a portion of the first component segment; a second curved plate including a first end configured to engage a fixed element, the fixed element including a portion of at least one of the second component segment or a half casing of the turbine section; a coupler coupling a second end of one of the first and second curved plates to the base; and a linear actuator between the base and a second end of the other one of the first and second curved plates, wherein the linear actuator linearly moves the first and second curved plates relative to one another between a first position in which the first ends of the first and second curved plates are retracted and a second position in which the first ends of the first and second curved plates are extended a distance from one another to force the first and second component segments to separate.

Another aspect of the disclosure includes any of the preceding aspects, and the first and second component segments each include a nozzle segment, and the first and second curved plates have a radius of curvature matching a radius of curvature of a space between the casing and a radial outer surface of the nozzle segments at the stage of the turbine section.

Another aspect of the disclosure includes any of the preceding aspects, and the linear actuator includes a hydraulic ram.

Another aspect of the disclosure includes any of the preceding aspects, and further comprising an axial spacer member including a third curved plate having an axial width configured to hold the first and second curved plates in an operative position in the stage of the turbine section with the first ends of the first and second curved plates between the portion of the first component segment and the fixed element.

Another aspect of the disclosure includes any of the preceding aspects, and the other one of the first and second curved plates has a first circumferential portion including the second end thereof, a second circumferential portion including the first end thereof, and an axial-extending portion coupling the first and second circumferential portions.

Another aspect of the disclosure includes any of the preceding aspects, and each of the first and second curved plates include a circumferential-extending portion and a perpendicular portion extending perpendicular to the circumferential-extending portion, wherein the first end of the first and second curved plates is located on the perpendicular portion thereof.

Another aspect of the disclosure includes any of the preceding aspects, and the perpendicular portion extends in an axial direction relative to an axis of the turbine section.

Another aspect of the disclosure includes any of the preceding aspects, and the perpendicular portion extends in a radially inward direction relative to an axis of the turbine section.

Another aspect of the disclosure includes any of the preceding aspects, and the coupler includes a body, a first connector at a first end of the body pivotally coupling the body to the base, and a second connector at a second, opposite end of the body pivotally coupling the body to the second end of the one of the first and second curved plates.

Another aspect of the disclosure includes any of the preceding aspects, and the body is length adjustable.

Another aspect of the disclosure includes any of the preceding aspects, and the linear actuator includes at least one of a first connector at a first end thereof fixedly coupling the linear actuator to the base or a second connector at a second, opposite end thereof fixedly coupling the linear actuator to the second end of the other one of the first and second curved plates.

Another aspect of the disclosure includes any of the preceding aspects, and the first and second curved plates include a radially-inward facing surface and a radially-outward facing surface, and further comprising at least one radial spacer on the radially-outward facing surface configured to position the respective curved plate in a radial position with the first end thereof between the portion of the first component segment and the fixed element.

Another aspect of the disclosure includes any of the preceding aspects, and further comprising a fixing member configured to lock a position of the second component segment relative to the casing.

Another aspect of the disclosure includes any of the preceding aspects, and the first curved plate and the second curved plate slide in contact with one another along at least part of a length thereof as the linear actuator moves the first and second curved plates relative to one another between the first position and the second position.

Another aspect of the disclosure includes a tool for separating a first nozzle segment from a second nozzle segment adjacent the first nozzle segment in a stage of a turbine section, the tool comprising: a base; a first curved plate including a first end configured to engage a portion of the first nozzle segment; a second curved plate including a first end configured to engage a fixed element, the fixed element including a portion of at least one of the second nozzle segment or a half casing of the turbine section; a coupler coupling a second end of one of the first and second curved plates to the base; and a linear actuator between the base and a second end of the other one of the first and second curved plates, wherein the linear actuator linearly moves the first and second curved plates relative to one another between a first position in which the first ends of the first and second curved plates are retracted and a second position in which the first ends of the first and second curved plates are extended a distance from one another to force the first and second nozzle segments to separate.

Another aspect of the disclosure includes any of the preceding aspects, and the first and second curved plates have a radius of curvature matching a radius of curvature of a space between the casing and a radial outer surface of the nozzle segments at the stage of the turbine section.

Another aspect of the disclosure includes any of the preceding aspects, and the other one of the first and second curved plates has a first circumferential portion including the second end thereof, a second circumferential portion including the first end thereof, and an axial-extending portion coupling the first and second circumferential portions.

Another aspect of the disclosure includes any of the preceding aspects, and each of the first and second curved plates include a circumferential-extending portion and a perpendicular portion extending perpendicular to the circumferential-extending portion, wherein the first end of the first and second curved plates is located on the perpendicular portion thereof, wherein the perpendicular portion extends in one of an axial direction relative to an axis of the turbine section and a radially inward direction relative to the axis of the turbine section.

Another aspect of the disclosure includes any of the preceding aspects, and the coupler includes a body that is length-adjustable, a first connector at a first end of the body pivotally coupling the body to the base, and a second connector at a second, opposite end of the body pivotally coupling the body to the second end of the one of the first and second curved plates.

Another aspect of the disclosure includes any of the preceding aspects, and the first and second curved plates include a radially-inward facing surface and a radially-outward facing surface, and further comprising at least one radial spacer on the radially-outward facing surface configured to position the respective curved plate in a radial position with the first end thereof between the portion of the first nozzle segment and the fixed element.

Another aspect of the disclosure includes any of the preceding aspects, and the first curved plate and the second curved plate slide in contact with one another along at least part of a length thereof as the linear actuator moves the second curved plate relative to one another between the first position and the second position.

Another aspect of the disclosure includes a method of separating a first and second adjacent nozzle segments in a half casing of a turbine system, comprising: circumferentially positioning a first and second curved plates of a separation tool along the first and second adjacent nozzle segments, wherein the first curved plate includes a first end for engaging a portion of the first nozzle segment and a second end coupled to a base of the separation tool, wherein the second curved plate includes a first end for engaging a fixed element and a second end coupled to the base by a linear actuator; axially positioning the first ends of the first and second curved plates between the portion of the first nozzle segment and the fixed element; and activating the linear actuator to move the first and second plates relative to one another between a first position in which the first ends of the first and second curved plates are retracted and a second position in which the first ends of the first and second curved plates are distanced from one another to force the first and second nozzle segments to separate.

Two or more aspects described in this disclosure, including those described in this summary section, may be combined to form implementations not specifically described herein. That is, all embodiments described herein can be combined with each other.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic view of a turbine system according to embodiments of the disclosure;

FIG. 2 shows a cross-sectional view of a turbine section of a turbine system according to embodiments of the disclosure;

FIG. 3 shows a perspective view of a tool positioned to separate first and second component segments in a half casing according to embodiments of the disclosure;

FIG. 4 shows an enlarged perspective view of a tool and the component segments in the half casing according to embodiments of the disclosure;

FIG. 5 shows a radially inward perspective view of a tool and the component segments according to embodiments of the disclosure;

FIG. 6 shows a side perspective view of a tool according to embodiments of the disclosure;

FIG. 7 shows a top-down view of a tool according to embodiments of the disclosure;

FIG. 8 shows a side view of a tool according to embodiments of the disclosure;

FIG. 9 shows a side view of a tool and component segments within a half casing according to embodiments of the disclosure;

FIG. 10 shows a perspective view of another option for perpendicular portion(s) of first and/or second curved plate(s) of a tool according to other embodiments of the disclosure;

FIG. 11 shows a bottom view of a tool according to other embodiments of the disclosure;

FIG. 12 shows a bottom view of a tool according to additional embodiments of the disclosure;

FIG. 13 shows a bottom perspective view of a tool according to other embodiments of the disclosure;

FIG. 14 shows a bottom perspective view of a tool with an axial spacer member according to further embodiments of the disclosure;

FIG. 15 shows a perspective view of a tool with an axial spacer member according to further embodiments of the disclosure;

FIGS. 16A-D show various bottom views of a tool prior to separating first and second component segments according to embodiments of the disclosure; and,

FIGS. 17A, 17B and 17D show various bottom views and FIG. 17C shows a perspective view of a tool with a linear actuator thereof activated to separate the component segments according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current technology, it will become necessary to select certain terminology when referring to and describing relevant machine components within the illustrative application of a turbine system. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbomachine or, for example, the flow of air through the combustor or coolant through one of the turbomachine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the turbomachine, and “aft” referring to the rearward or turbine end of the turbomachine.

It is often required to describe parts that are at different radial positions with regard to a center axis. The term “axial” refers to movement or position parallel to an axis, e.g., an axis of a turbomachine. The term “radial” refers to movement or position perpendicular to an axis, e.g., an axis of a turbomachine. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential interior surface of a half casing extending about an axis of a turbomachine. As indicated above, it will be appreciated that such terms may be applied in relation to the axis of the turbomachine.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs or the feature is present and instances where the event does not occur or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

Embodiments of the disclosure include a tool for separating a first component segment from a second component segment adjacent the first component segment in a stage of a turbine section. For purposes of description, a tool according to embodiments of the disclosure will be described relative to component segments in the form of nozzle segments. It is emphasized that the teachings of the disclosure may be applied to other types of component segments in a turbine system, such as shroud segments or blade segments. The tool includes a base, a first curved plate including a first end configured to engage a portion of the first component segment, and a second curved plate including a first end configured to engage a fixed element. The fixed element may include a portion of at least one of the second component segment or a half casing of the turbine section. A coupler couples a second end of one of the first and second curved plates to the base, and a linear actuator is between the base and a second end of the other one of the first and second curved plates. The linear actuator linearly moves the first and second curved plates relative to one another between a first position in which the first ends of the first and second curved plates are retracted and a second position in which the first ends of the first and second curved plates are extended a distance from one another to force the first and second component segments to separate. The tool applies a separation force in a safe manner apart from any sensitive structure, such as airfoils, and reduces the disassembly time required. The tool only requires one user to operate and, in most cases, does not require access from outside the casing to operate. Further, the tool is highly customizable for applicability in different situations.

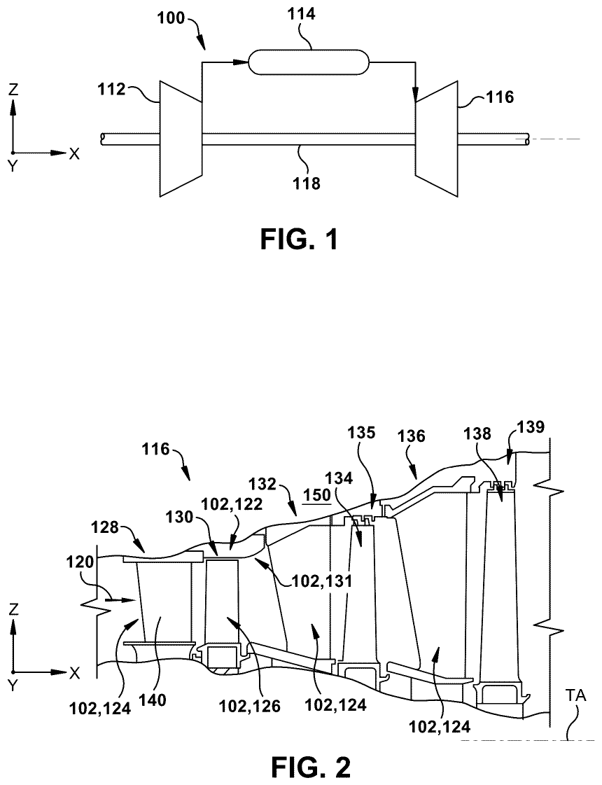

FIG. 1 is a schematic diagram of an illustrative turbine system 100, such as a gas turbine (GT) system, that uses component segments 102A-B (FIGS. 2-4) according to embodiments of the disclosure. Turbine system 100 of the present disclosure need not be a gas turbine system, but rather may be any suitable turbine system, such as a steam turbine system, jet engine, or other suitable system. Illustrative turbine system 100 may include a compressor section 112, a combustor section 114, and a turbine section 116. Compressor section 112 and turbine section 116 may be coupled by a shaft 118. Shaft 118 may be a single shaft or a plurality of shaft segments coupled together to form shaft 118. Shaft defines an X axis of turbine system 100 (labeled in FIG. 2 as “TA” for “turbine axis”). As is generally known in the art, air or another suitable working fluid flows through and is compressed in compressor section 112. The compressed working fluid is then supplied to combustor section 114, wherein it is combined with fuel and combusted, creating hot combustion gases. After the hot combustion gas flows through combustor section 114, it may flow into and through turbine section 116.

FIG. 2 illustrates some embodiment of portions of turbine section 116 according to the present disclosure. A hot gas path 120 may be defined within turbine section 116. Various hot gas path component stages, such as shroud segments 122, stationary nozzle segments 124, and turbine rotor blade segments 126, may be at least partially disposed in hot gas path 120. For example, as shown, turbine section 116 may include a plurality of shroud segments 122, a plurality of nozzle segments 124 and a plurality of turbine rotor blade segments 126, which are arranged in a plurality of turbine stages. More particularly, the stages include a plurality of circumferentially adjacent component segments 102. That is, each stage of the components in turbine section 116 typically may be formed with component segments 102 that are placed circumferentially end-to-end to form a continuous ring or annular array within a turbine casing of turbine section 116. For example, each stage may include a plurality of nozzle segments 124 disposed in an annular array and a plurality of turbine rotor blade segments 126 disposed in an annular array. Each stage may also include a plurality of shroud segments 122 disposed in an annular array, i.e., radially outward of a respective plurality of turbine rotor blade segments 126. Each annular array may define a portion of hot gas path 120.

In one example, as shown in FIG. 2, turbine section 116 may have three stages. For example, a first stage of turbine section 116 may include a first stage nozzle assembly 128, a first stage blade assembly 130 and a first stage shroud assembly 131. Nozzle assembly 128 may include a plurality of nozzle segments 124 disposed and fixed circumferentially about shaft 118. Blade assembly 130 may include a plurality of turbine rotor blade segments 126 disposed circumferentially about shaft 118 and coupled to shaft 118. Shroud assembly 131 may include a plurality of shroud segments 122 disposed circumferentially about shaft 118 and fixed circumferentially about shaft 118, e.g., in a stationary turbine casing 150. Similarly, a second stage of turbine section 116 may include a second stage nozzle assembly 132, a second stage blade assembly 134 and a second stage shroud assembly 135. Nozzle segments 124 included in second stage nozzle assembly 132 may be disposed and fixed circumferentially about shaft 118. Turbine rotor blade segments 126 included in second stage blade assembly 134 may be disposed circumferentially about shaft 118 and coupled to shaft 118. Shroud segments 122 included in second stage shroud assembly 135 may be disposed and fixed circumferentially about shaft 118. Second stage nozzle assembly 132 is positioned between first stage blade assembly 130 and second stage blade assembly 134 (and second stage shroud assembly 135) along hot gas path 120. Similarly, a third stage of turbine section 116 may include a third stage nozzle assembly 136, a third stage blade assembly 138 and a third stage shroud assembly 139. Nozzle segments 124 included in nozzle assembly 136 may be disposed and fixed circumferentially about shaft 118. Turbine rotor blade segments 126 included in blade assembly 138 may be disposed circumferentially about shaft 118 and coupled to shaft 118. Shroud segments 122 included in shroud assembly 139 may be disposed and fixed circumferentially about shaft 118. Third stage nozzle assembly 136 is positioned between second stage blade assembly 134 and third stage blade assembly 138 (and third stage shroud assembly 139) along hot gas path 120.

Turbine section 116 is not limited to three stages, but rather that any number of stages are within the scope and spirit of the present disclosure. It should be understood that teachings of the present disclosure are not limited to component segments 102 in turbine section 116 but could also be component segments 102 at least partially disposed in flow paths for compressor section 112 or any other suitable sections of turbine system 100. Further, shroud segments 122 in shroud assemblies 131, 135, 139, and nozzle segments 124 in nozzle assemblies 128, 132, and 136 may be fixedly coupled to turbine casing 150 that circumscribes shaft 118 (FIG. 1).

In operation of turbine system 100, hot gas component segments 102, such as nozzle segments 124, are positioned along hot gas path 120 of turbine section 116 are subject to not only high temperatures and pressures but also different types of dynamic forces. As noted, given such environments, these component segments 102 may be replaced and/or refurbished on a periodic basis to ensure efficient and safe performance of turbine system 100. Removal of component segments 102 may be difficult and time consuming, especially where the extreme environments cause component segments 102 to stick together and/or to be seized in the supporting structure.

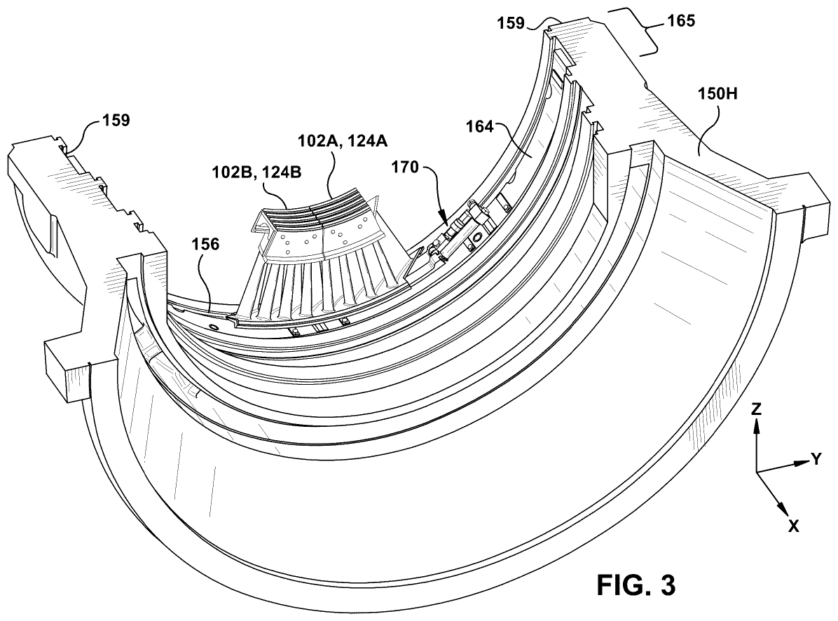

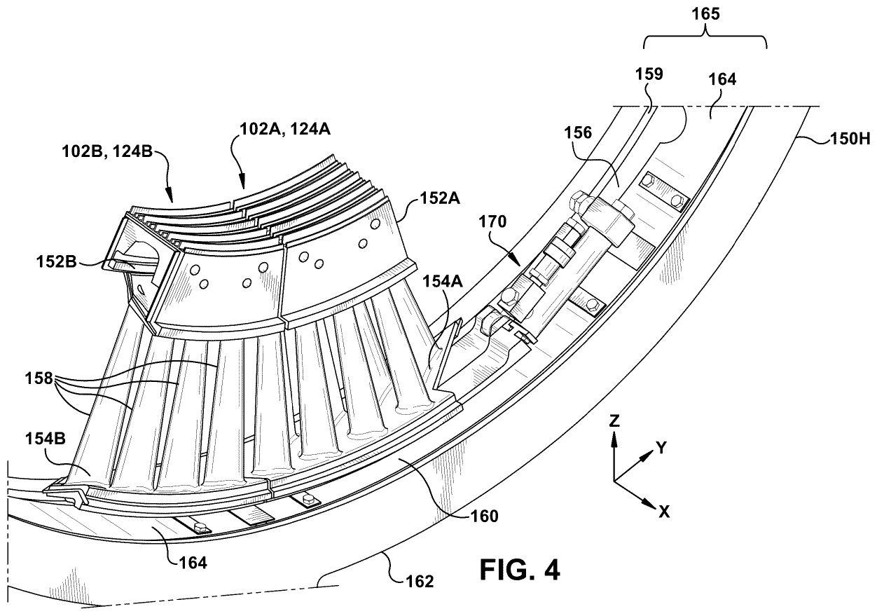

FIG. 3 shows a perspective view of a half portion of turbine casing 150H (hereafter “half casing 150H” for brevity) with a first component segment 102A (circumferentially) adjacent a second component segment 102B, and FIG. 4 shows an enlarged perspective view of component segments 102A-B in half casing 150H. Half casing 150H is shown as a lower half casing after an upper half casing (not shown) has been removed and other component segments have been removed except for the last two component segments 102A, 102B. FIGS. 3 and 4 also show a tool 170 for separating adjacent component segments 102A-B.

For purposes of description, tool 170 will be described relative to component segments 102A-B in the form of nozzle segments 124A-B (FIG. 2). Hence, FIGS. 3 and 4 also show first nozzle segment 124A adjacent second nozzle segment 124B. Accordingly, the terms “component segments” and “nozzle segments” may be both used herein and are, generally, interchangeable. As understood in the field, each stage of component segments 102 in turbine section 116 typically may be formed by placing them circumferentially end-to-end to form a continuous ring or annular array within collective pairs of half casings 150H of turbine section 116 (FIG. 1) (and then putting the two half casings together). More particularly, in FIGS. 3 and 4, nozzle segments 124A-B are shown with outer endwalls 154A-B (rotor already removed) free in space and inner endwalls 152A-B in a support structure 156 in the form of a slot in half casing 150H. It will be recognized that support structure 156 can have a variety of alternative forms and positions depending on the type of component segment 102 for which it is employed. In any event, component segments 102A-B, e.g., nozzle segments 124A, 124B, are slidingly positioned end-to-end in a circumferentially-extending support structure 156. In FIGS. 3 and 4, nozzle segments 124A-B are shown with four airfoils 158 each, but any number of airfoils 158 may be used on each nozzle segment 124A-B, e.g., one, two, three or more than four. The number of airfoils 158 used may dictate the circumferential extent of each nozzle segment 124A-B. Other types of component segments 102 may have different circumferential extents. As will be described, tool 170 can be customized to handle component segments 102A-B having any circumferential extent.

Component segments 102A-B, such as nozzle segments 124A-B, are typically removed by sliding them circumferentially along support structure 156, e.g., a slot, until they exit support structure 156 at an end 159 thereof. As noted, the extreme environments of turbine section 116, such as high temperature and high-pressure, may cause component segments 102, such as nozzle segments 124A-B, to stick together and/or to be seized in supporting structure 156. As shown in FIG. 4, a space 160 between a radial outer end 162 of nozzle segments 124A, 124B and half casing 150H is relatively small, making access to nozzle segments 124A-B for tools for separation and/or removal very challenging. In some cases, space 160 is made even smaller by the presence of an insulator layer 164 disposed between radial outer end 162 of nozzle segments 124A, 124B and half casing 150H. Similar challenges are present for other types of component segments 102, e.g., shroud segments 122 (FIG. 2) or blade segments 126 (FIG. 2), in turbine section 116 (FIG. 1) and for component segments 102 in other types of turbine systems.

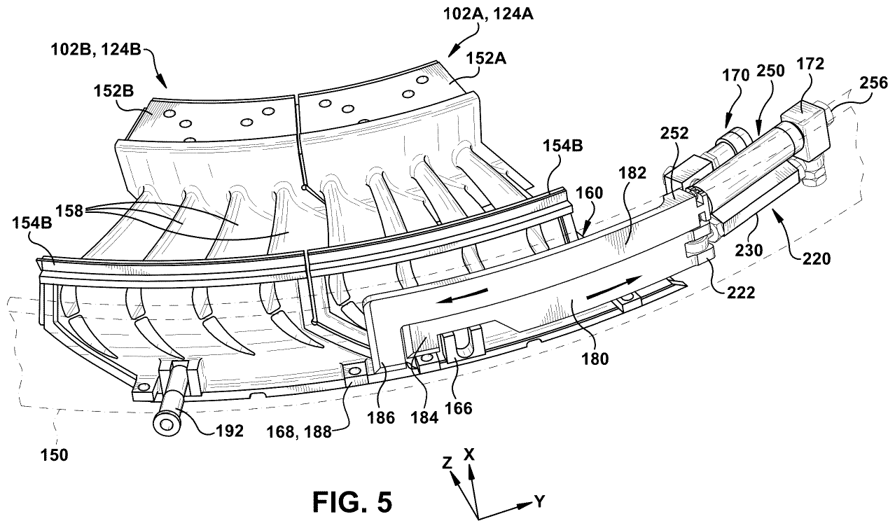

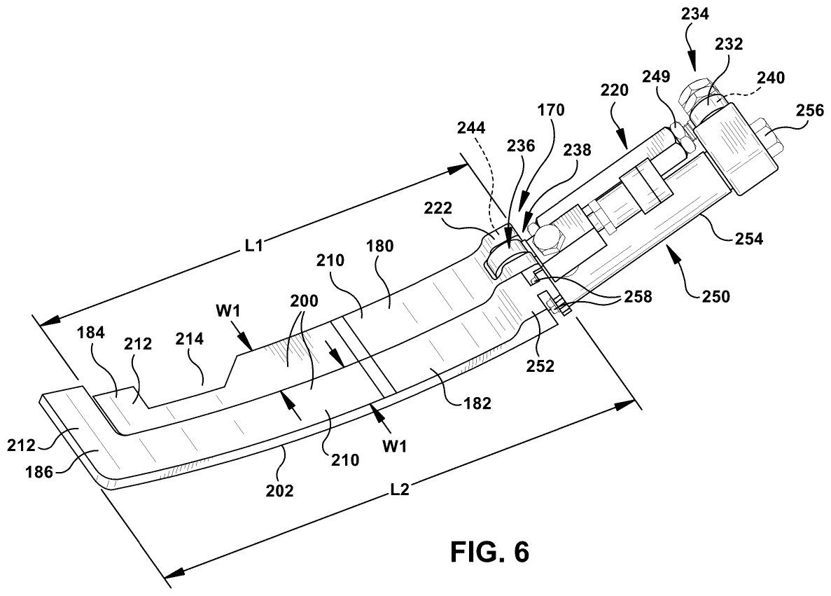

Tool 170 is shown in position in half casing 150H to separate first component segment 102A from second component segment 102B adjacent first component segment 102A in a given stage 165 (FIGS. 3, 4, 9, 17C) of turbine section 116 (FIGS. 1-2), e.g., a second stage in half casing 150H of the turbine section. That is, tool 170 is shown in position to separate first nozzle segment 124A from second nozzle segment 124B adjacent first nozzle segment 124A in a particular stage 165 of turbine section 116 (FIGS. 1-2). FIG. 5 shows a radially inward perspective view of tool 170 and nozzle segments 124A, 124B. As will be described, first nozzle segment 124A includes a portion 166 that may be engaged by a part of tool 170, and second nozzle segment 124B may include a portion 168 that may be engaged by a part of tool 170. In the example shown in FIG. 5, portions 166, 168 may be flanges or other structure that extend radially outward from outer endwalls 154A, 154B, respectively. It will be recognized that portions 166, 168 may take a large variety of other configurations depending on, for example, the type of component segment 102, stage in which used, type of turbomachine, among other factors.

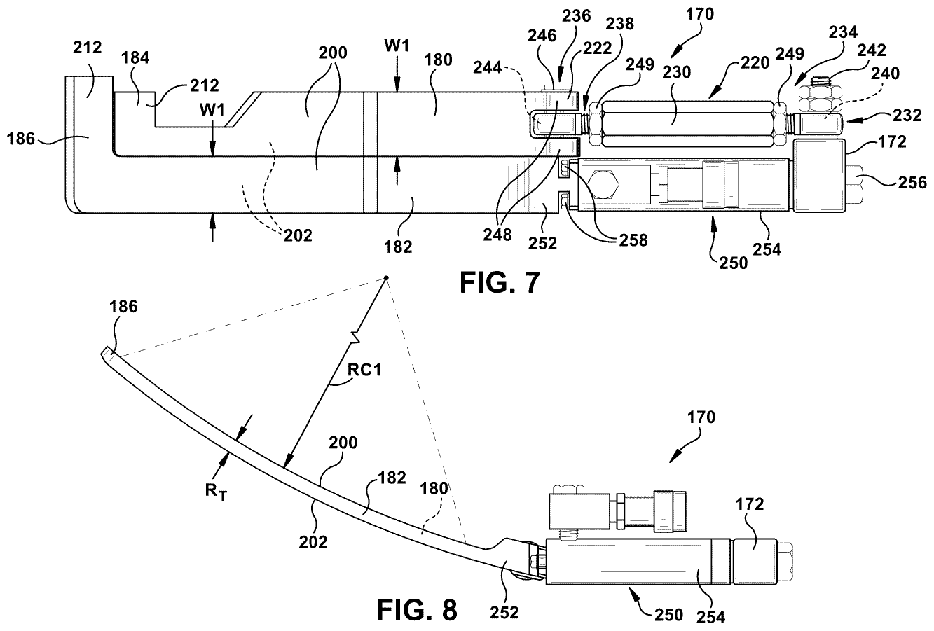

The structure of tool 170 will now be described with reference to FIGS. 6-15. FIG. 6 shows a side perspective view of tool 170, FIG. 7 shows a top-down view of tool 170, and FIG. 8 shows a side view of tool 170, according to embodiments of the disclosure. Tool 170 includes a base 172. Base 172 may include any structural element to which other parts of tool 170 can be coupled for operation, as will be described herein. Base 172 may also provide a structure through which tool 170 can be positioned, e.g., in half casing 150 and/or in storage during non-use. Base 172 and, hence, tool 170 may be positioned manually by a user or using any form of automated lift system, e.g., an overhead crane or gantry, robotic arm, etc.

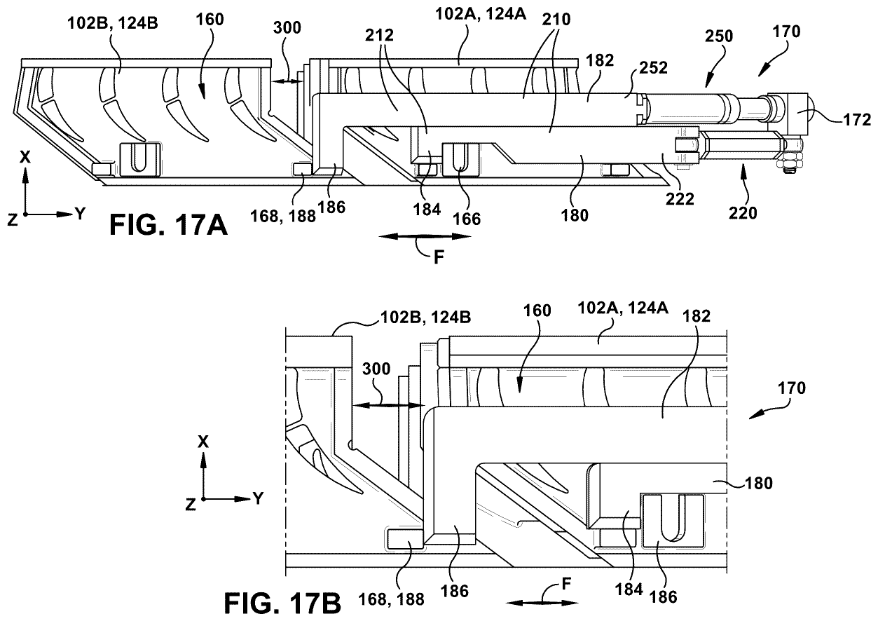

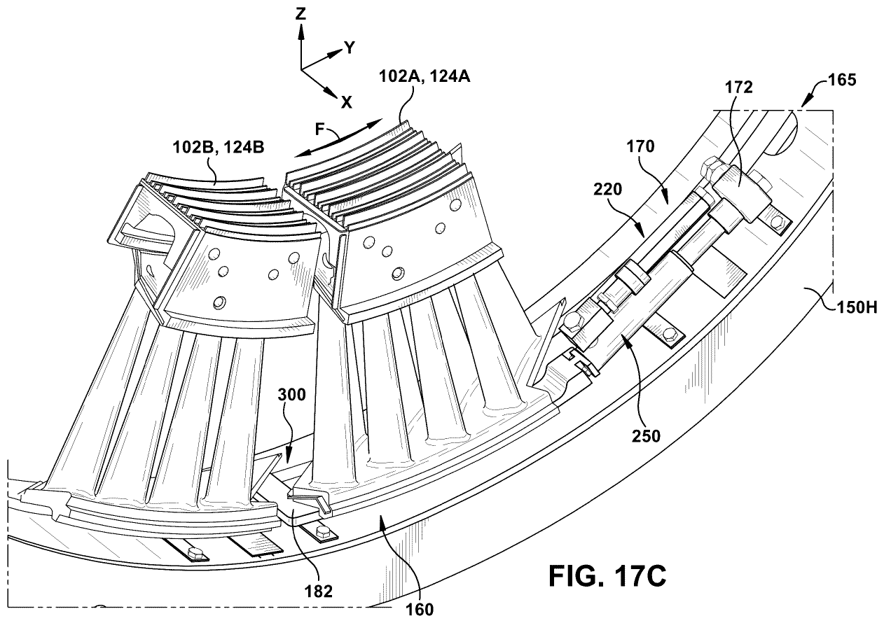

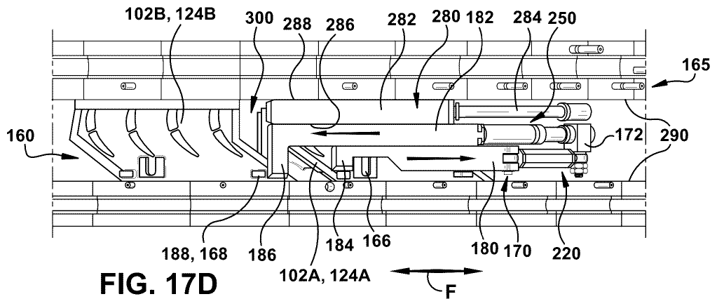

Tool 170 also includes a pair of curved plates 180, 182 configured for positioning within space 160 to separate component segments 102A-B, such as nozzle segments 124A-B. More particularly, tool 170 includes a first curved plate 180 including a first end 184 configured to engage portion 166 of a nozzle segment, e.g., first nozzle segment 124A. Similarly, second curved plate 182 includes a first end 186 configured to engage a fixed element 188. Fixed element 188 may include any now known or later developed structure accessible within space 160 and capable of resisting a separation force F (FIGS. 17A-D) applied thereto by tool 170. In certain embodiments, fixed element 188 may include a portion of at least one of second nozzle segment 124B or half casing 150H of turbine section 116 (FIGS. 1-2). In FIG. 5, fixed element 188 may include portion 168 of second nozzle segment 124B, as previously described. Portion 168 is fixed in position because second nozzle segment 124B is fixed in position. Second nozzle segment 124B may be fixed in position in several ways. For example, second nozzle segment 124B may be fixed in position by mere adjacency and contact with other nozzle segments (not shown but would be to the left in FIG. 5) that have not been moved or separated from support structure 156. Alternatively, nozzle segment 124B may be fixed in position from operation in turbine section 116 (FIG. 1) through seizing in support structure 156. Alternatively, or in addition to the previously described mechanisms for second nozzle segment 124B to be fixed in position, as shown in FIG. 5, second nozzle segment 124B may be optionally fixed in position by a fixing member 192 configured to lock a position of second nozzle segment 124B relative to half casing 150H, i.e., within support structure 156. This latter option may be desired where the earlier described options are insufficient to hold second nozzle segment 124B in position, e.g., where it is the penultimate nozzle segment 124 remaining in support structure 156. Fixing member 192 may include any structure capable of fixing movement of second nozzle segment 124B relative to half casing 150H and may include, for example, a pin (see FIG. 5) extending through half casing 150H, a blocking element in space 160, or other structure(s).

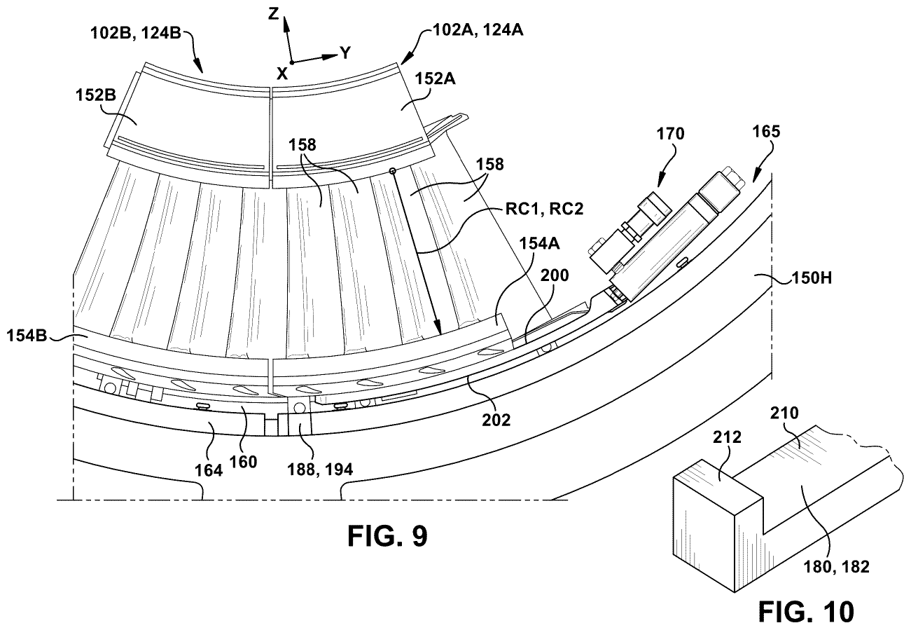

FIG. 9 shows a side view of tool 170 and nozzle segments 124A, 124B within half casing 150H. FIG. 9 shows an example in which fixed element 188 includes a portion 194 of half casing 150H. Portion 194 of half casing 150H may include but is not limited to a flange, edge, or other structure capable of engaging first end 186 of second curved plate 182. Although unlikely, first end 186 of second curved plate 182 may engage both portion 166 of second curved plate 182 and portion 194 of half casing 150H, e.g., where they are circumferentially aligned. Also, in FIG. 9, portion 194 of half casing 150H is axially arranged, for example, into and out of page of FIG. 9. FIG. 9 shows, as will be further described herein, how tool 170 and, in particular, curved plates 180, 182 may be positioned circumferentially (along Y-direction, side-to-side on page) into space 160 and then positioned axially (in the X-direction, into or out of the page) to position first ends 184, 186 thereof between portion 166 of first component segment 102A and fixed element 188, e.g., portion 194 of half casing 150H.

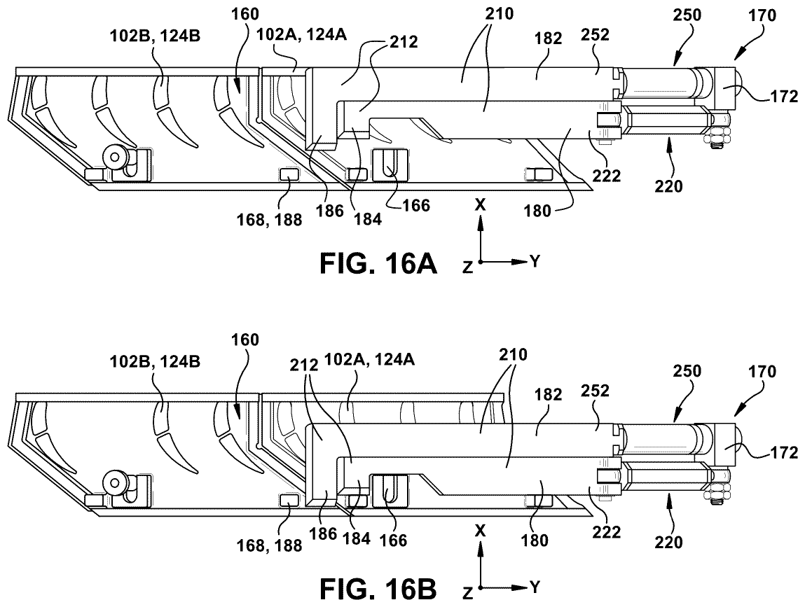

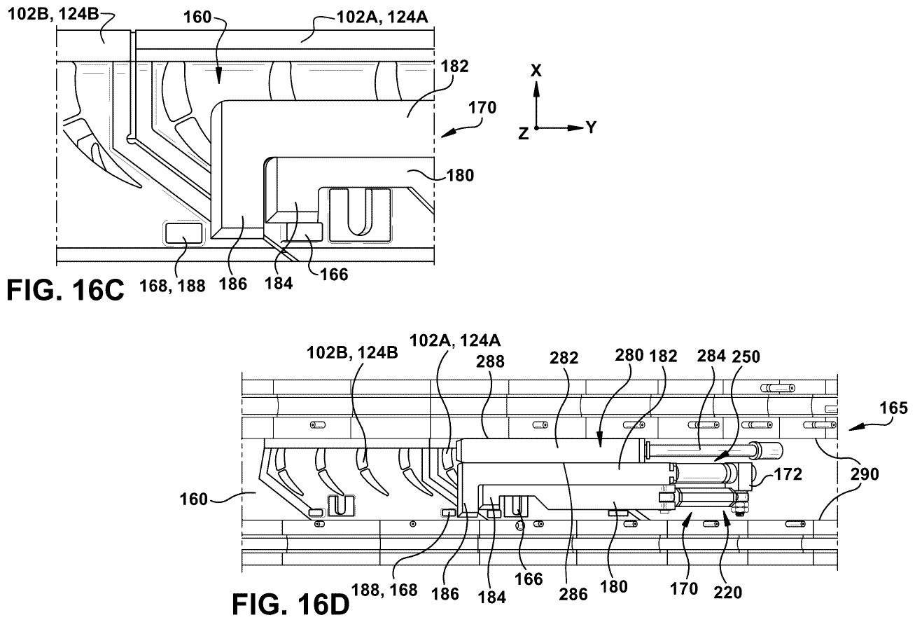

Referring to FIGS. 6-7, first and second curved plates 180, 182 include a radially inward facing surface 200 and a radially outward facing surface 202. Surfaces 200, 202 are curved and have an axial width W1 sized to allow curved plates 180, 182 to be axially positioned within space 160, as will be further described. First and second curved plates 180, 182 also include a circumferential-extending portion 210 and a perpendicular portion 212 extending perpendicular to circumferential-extending portion 210. First ends 184, 186 of first and second curved plates 180, 182 are located on respective perpendicular portions 212 thereof. Second curved plate 182 is L-shaped. In contrast, first curved plate 180 may have a recess 214 removing at least a portion of circumferential-extending portion 210 thereof to partially create perpendicular portion 212. However, this arrangement for first curved plate 180 is not necessary in all cases, i.e., it could be L-shaped also. In FIGS. 6-7, perpendicular portions 212 of first and second curved plates 180, 182 extend in an axial direction, i.e., X-direction, relative to an axis of turbine section 116 and respective circumferentially extending portions 210. Hence, first and second curved plates 180, 182 can nest together in an axial direction. As will be described, although not necessary in all cases, first curved plate 180 and second curved plate 182 may slide in contact with one another along at least part of a length (L1, L2) thereof as a linear actuator 250 moves first and second curved plates 180, 182 relative to one another between retracted and extended positions (see e.g., FIGS. 16B-D and 17A-D).

FIG. 10 shows a perspective view of another option for perpendicular portion(s) 212 of first and/or second curved plate(s) 180, 182. In this arrangement, perpendicular portion(s) 212 extend in a radial direction, i.e., a Y direction, relative to an axis of turbine section 116 and relative to circumferentially extending portions 210 thereof. The FIG. 10 arrangement may be advantageous where space 160 has a sufficient radial extent for perpendicular portion(s) 212 to extend radially, and portion 166 and fixed element 188 (to be engaged by first ends 184, 186 on perpendicular portion(s) 212) are not engageable in a circumferential direction by first ends 184, 186. For example, portion 166 may be recessed in first nozzle segment 124A and/or fixed element 188 may be recessed in second nozzle segment 124B or half casing 150H. Although shown extending a particular radial direction (up on page) in FIG. 10, perpendicular portion(s) 212 may extend in a radial inward direction and/or a radial outward direction, i.e., either Z direction, relative to an axis of turbine section 116 and relative to circumferentially extending portions 210 thereof. In any event, the different embodiments of perpendicular portions 212 described herein can be mixed and matched in any manner to provide the necessary position of first ends 184, 186 of curved plates 180, 182 to engage portion 166 of first nozzle segment 124A and fixed element 188 of, e.g., portion 166 of second nozzle segment 124B or portion 194 of half casing 150H.

Tool 170 also includes a coupler 220 coupling a second end 222 of one of first and second curved plates 180 (shown), 182 to base 172. Coupler 220 can include any now known or later developed mechanical connection. Coupler 220 may be pivotally or non-pivotally coupled to base 172 using any solution, such as threaded fasteners, welding, etc. In the non-limiting example shown, coupler 220 is pivotally coupled to base 172. In certain embodiments, as shown in FIGS. 6-7, coupler 220 includes a body 230, a first connector 232 at a first end 234 of body 230 pivotally coupling body 230 to base 172, and a second connector 236 at a second, opposite end 238 of body 230 pivotally coupling body 230 to second end 222 of one of first and second curved plates 180 (shown), 182. More specifically, coupler 220 is pivotally coupled to base 172 using first connector 232 having a threaded eyelet 240. A threaded pin 242 (FIG. 7) of base 172 extends through the opening in threaded eyelet 240 in an end of coupler 220 with bolts (not labeled) threaded thereon. Similarly, coupler 220 may be pivotally or non-pivotally coupled to second end 222 of curved plate 180 using any solution. In the non-limiting example shown, coupler 220 is coupled to curved plate 182 at second end 238 of body 230 by second connector 236 that includes a threaded eyelet 244. A pin 246 couples threaded eyelet 244 to a forked end 248 of second end 222 of curved plate 180.

In certain embodiments, body 230 of coupler 220 may be length-adjustable, which can be provided in any now known or later developed manner. In the example shown, a length of body 230 can be adjusted using threaded connections 249 (e.g., bolts) that are threaded onto threaded eyelets 240 on opposing ends of body 230. It will be recognized that coupler 220 may be length-adjustable for initial set up of tool 170 but that it is probably not length-adjustable during use of tool 170—in contrast to linear actuator 250, as will be further described. That is, coupler 220 is length-adjustable to accommodate setting the desired position of, for example, first curved plate 180 relative to base 172, and then coupler 220 remains at that fixed length during use of tool 170. While illustrative connections have been described for coupler 220, it will be recognized that a large variety of alternative connections and body arrangements for coupler 220 are possible and considered within the scope of the disclosure.

Tool 170 also includes a linear actuator 250 between base 172 and a second end 252 of the other one of the first and second curved plates 180, 182 (shown). Linear actuator 250 may include any now known or later developed actuator for linearly moving the selected, attached curved plate 182. In certain embodiments, as shown, linear actuator 250 may include a hydraulic ram 254. Linear actuator 250 may alternately include a pneumatic or electric ram, or a length adjustable mechanical structure, the latter of which will be described further herein.

Linear actuator 250, e.g., hydraulic ram 254, may be fixedly or pivotally coupled to base 172 using any solution, such as threaded fasteners, welding, etc. In the non-limiting example shown in, for example, FIGS. 5-7, linear actuator 250 is fixedly coupled to base 172 using a first connector 256 in the form of, for example, a threaded fastener such as a threaded bolt threaded through base 172 and into an end of linear actuator 250. Similarly, linear actuator 250, e.g., hydraulic ram 254, may be fixedly coupled to second end 252 of second curved plate 182 using any solution. In the non-limiting example shown, linear actuator 250 is coupled to second curved plate 182 using a second connector 258 including, for example, threaded fasteners threaded into an end of linear actuator 250. Hence, linear actuator 250 includes at least one of a first connector 256 at first end thereof fixedly coupling linear actuator 250 to base 172 or a second connector 258 at a second, opposite end thereof fixedly coupling linear actuator 250 to second end 252 of second curved plate 182. Other forms of connectors for linear actuator 250 to base 172 and second curved plate 182 are possible.

FIG. 11 shows a bottom view of tool 170 according to other embodiments of the disclosure. In FIG. 11, the position of coupler 220 and linear actuator 250 have been switched with coupler 220 coupled to second end 252 of second curved plate 182, and linear actuator 250 coupled to second end 222 of first curved plate 180. In addition, in FIG. 11, coupler 220 has been replaced by a non-pivotal connection with base 172 and second curved plate 182. In one non-limiting example, coupler 220 may include a non-length adjustable bar or member 259 welded to second end 252 of second curved plate 182 at end 238 thereof and to base 172 at end 234 thereof. Other non-length adjustable couplers 220 are also possible and are considered within the scope of the disclosure. In FIG. 11, linear actuator 250 includes a turnbuckle 260 held by connections 262 to second end 222 of first curved plate 180 and to base 172. Connections 262 can take any form, including a threaded eyelet connection similar to that shown in FIG. 7. Other forms of linear actuator 250 may also be possible and are considered within the scope of the disclosure.

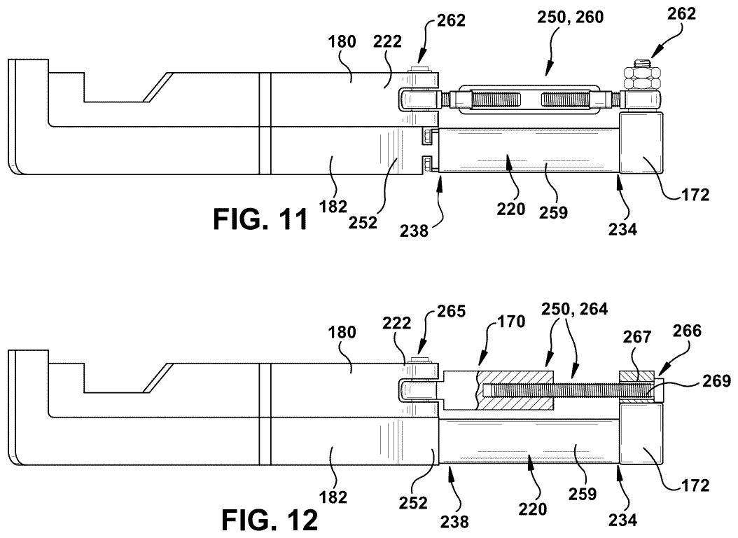

FIG. 12 shows a bottom view of tool 170 according to additional embodiments of the disclosure. In FIG. 12, as in FIG. 11, the position of coupler 220 and linear actuator 250 have been switched with coupler 220 coupled to second end 252 of second curved plate 182, and linear actuator 250 coupled to second end 222 of first curved plate 180. In addition, as in FIG. 11, coupler 220 has been replaced by a non-pivotal connection with base 172 and second curved plate 182, e.g., as a non-length adjustable bar or member 259 welded to second end 252 of curved plate 182 at end 238 thereof and to base 172 at end 234 thereof. In FIG. 12, linear actuator 250 includes a length-adjustable threaded member 264 held by a pin connection 265 to second end 222 of first curved plate 180 and extending through an opening 267 in base 172 through which a head 269 of threaded member 264 can be rotatably adjusted, e.g., with a screwdriver or hex head for rotating adjustment, to adjust a length linear actuator 250. Connection 265 to second end 222 of first curved plate 180 can take any form, including a pinned connection similar to that shown in FIG. 7. As noted, other forms of linear actuator 250 may also be possible and are considered within the scope of the disclosure.

In any of the embodiments described herein, the dimensions of curved plates 180, 182 can be configured for use with any stage 165 (FIGS. 3, 4, 9, 17C) of turbine section 116 (FIGS. 1-2) in which tool 170 is used. For example, as shown in FIGS. 6-9 and as previously noted, first and second curved plates 180, 182 include radially-inward facing surface 200 and radially-outward facing surface 202. Surfaces 200, 202 are curved and have an axial width W1 (FIGS. 6 and 8) sized to allow curved plates 180, 182 to be axially positioned within space 160 (into/out of page of FIG. 9), as will be further described. While axial widths W1 of curved plates 180, 182 are shown as equal that is not necessary in all cases so long as, collectively, curved plates 180, 182 can be positioned axially within space 160 in a manner described herein. Curved plates 180, 182 also have a radial thickness RT (FIG. 8) configured to allow positioning within space 160. As shown in FIG. 6, first and second curved plates 180, 182 also have a length L1, L2, respectively, configured to allow positioning within space 160 and engagement of portion 166 and fixed element 188, as described herein. Lengths L1, L2 are also configured to position base 172 outside of nozzle segments 124A-B. Curved plates 180, 182 also have a radius of curvature RC1 (FIGS. 8 and 9) matching a radius of curvature RC2 (FIG. 9) of space 160 between half casing 150H and radial outer ends 162 of nozzle segments 124A, 124B at the particular stage 165 (FIGS. 3, 4, 9, 17C) of turbine section 116 (FIGS. 1-2). As used herein, “matching” or “match” as it is applied to radius of curvatures RC, RC2 indicates curved plates 180, 182 can circumferentially move within space 160 with sufficient clearance to avoid snags or blocking until positioned where necessary for operation of tool 170.

The dimensions of curved plates 180, 182 can be customized or configured in several ways. More particularly, any axial width(s) W1 (FIGS. 6 and 8) of each curved plate 180, 182, a radial thickness RT, radius of curvature RC1 and/or lengths L1, L2 of each curved plate 180, 182 can be sized to accommodate any space 160 and/or configuration of portion 166 and fixed element 188. In contrast to conventional separation tools, since axial widths W1 (FIGS. 6 and 8) are greater than radial thickness RT, the largest area of curved plates 180, 182 are their radially-inward facing surface 200 and radially-outward facing surface 202. The radius of curvature RC1 (FIGS. 8 and 9) and the relatively thin radial thickness RT (FIG. 8) allow curved plates 180, 182 to be positioned in practically any sized space 160 in different stages 165 and regardless of whether insulation layer 164 (FIG. 4) is present or not. In addition, due to the radius of curvature RC1 and the relatively thin radial thickness RT, the lengths L1, L2 of curved plates 180, 182 and the overall circumferential reach of tool 170 can be set at any desired extent, which increases the applicability of tool 170 to a larger variety of small spaces 160 in different stages 165. Hence, tool 170 can be applied to a larger variety of different sized component segments 102A, 102B, such as but not limited to nozzle segments 124A, 124B, which have different circumferential extents due to, for example, more or less airfoils 158 thereon. Customization of lengths L1, L2 of curved plates 180, 182 also allow tool 170 to provide more options as to what portions of component segments 102 or half casing 150H are used for engagement by curved plates 180, 182. Tool 170 may also include different sets of curved plates 180, 182 having different dimensions to accommodate, for example, different arrangements of portion 166 of first component segment 102A and fixed element 188 within: a given stage 165, different stages 165 within a given turbine section 116 (FIGS. 1-2), different turbine sections 116 (FIGS. 1-2) within a given turbine system 100 (FIG. 1), and/or different turbine systems 100 (FIG. 1).

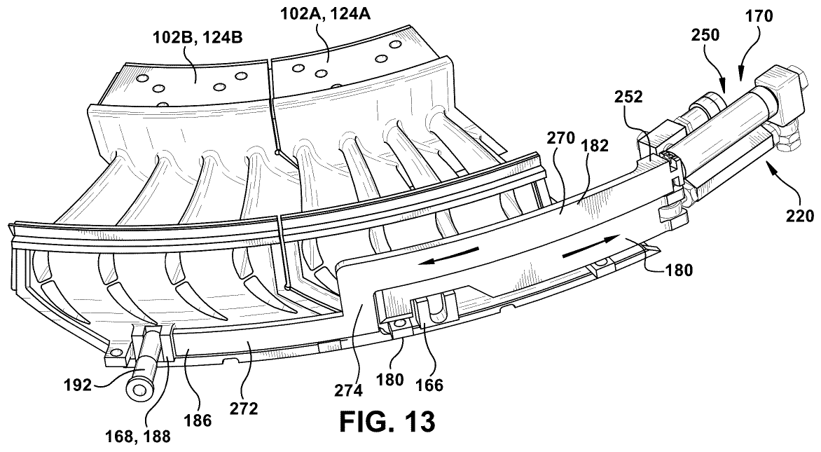

FIG. 13 shows a bottom perspective view of tool 170 according to other embodiments of the disclosure. FIG. 13 shows one example of changing dimensions of curved plate(s) 180, 182. In this example, fixed element 188 includes portion 168 of second component segment 102B, e.g., second nozzle segment 124B, that is farther from base 172 circumferentially than in the other drawings. In this case, second curved plate 182 may be configured to have first end 186 thereof extend farther circumferentially than in the other drawings. To this end, second curved plate 182 may include a first circumferential portion 270 including second end 252 thereof (coupled to linear actuator 250), a second circumferential portion 272 including first end 186 thereof, and an axial-extending portion 274 coupling first and second circumferential portions 270, 272. Here, axial-extending portion 274 axially positions first end 186 and second circumferential portion 272 acts to further circumferentially extend second curved plate 182 to engage fixed element 188, i.e., portion 168 of second component segment 102B. Otherwise, second curved plate 182 of FIG. 13 can be dimensioned as described herein. For example, first curved plate 180 may nest with second curve plate 182 as previously described.

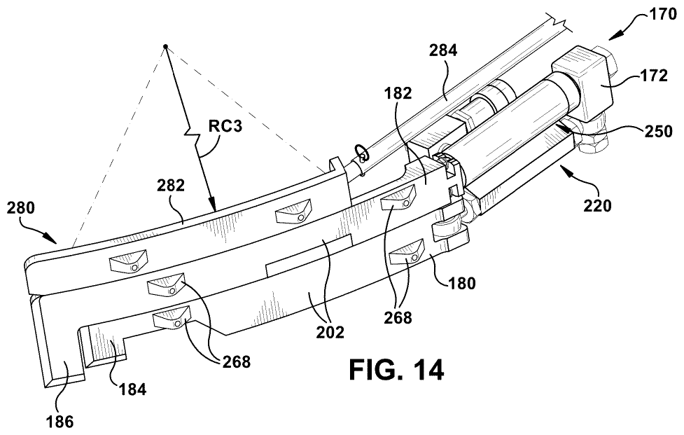

FIG. 14 shows a bottom perspective view of tool 170 according to other embodiments of the disclosure. FIG. 14 shows another example of changing dimensions of curved plate(s) 180, 182. In some cases, one or both curved plates 180, 182 may fall out of radial position or may be difficult to radially position within space 160, e.g., between portion 166 of first component segment 102A and fixed element 188 of second component segment 102B or half casing 150H. To address this situation, tool 170 may further optionally include at least one radial spacer 268 on, for example, radially outward facing surface 202 of one or both curved plates 180, 182. Radial spacer(s) 268 are configured to position the respective curved plate 180, 182 in a radial position with first end 184, 186 thereof between portion 166 of first component segments 102A and fixed element 188 of second component segment 102B or half casing 150H, respectively. Radial spacer(s) 268 may slidingly engage a surface of half casing 150H or insulation layer 164 (FIG. 4) thereon to radially position curved plates 180, 182 as noted. Radial spacer(s) 268 may be located and dimensioned based on need, which may depend on, for example, a radial size or radius of curvature RC2 (FIG. 9) of space 160, the radial position of portion 166 of first component segments 102A and fixed element 188 of second component segment 102B or half casing 150H, among other factors. Although not shown, radial spacer(s) 268 may also be positioned on radially inward facing surface 200 of one or both curved plates 180, 182, or on both radially inward facing surface 200 and radially outward-facing surface 200 of curved plate(s) 180, 182.

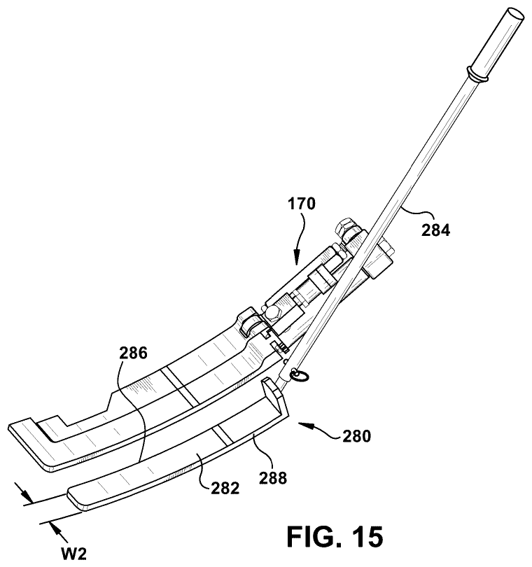

FIG. 14 also shows tool 170 including an axial spacer member 280. FIG. 15 shows a perspective view of tool 170 with axial spacer member 280. Axial spacer member 280 may be used where curved plates 180, 182 may need additional axial positioning than otherwise available, e.g., by manual manipulation by a user, within space 160 to remain between portion 166 of first component segment 102A (nozzle segment 124A) and fixed element 188 (portion 168 of second component segment 102B (nozzle segment 124B) or portion 194 of half casing 150H)). Axial spacer member 280 may include a (third) curved plate 282 having an axial width W2 configured to axially position (and hold) first and second curved plates 180, 182 in an operative position in stage 165 (FIGS. 3, 4, 9 and 17C) of turbine section 116 (FIGS. 1-2) with first ends 184, 186 of first and second curved plates 180, 182 between portion 166 of first component segment 102A and fixed element 188. Third curved plate 282 may have a radius of curvature RC 3 (FIG. 14) the same as or similar to that of curved plates 180, 182. Axial spacer member 280 may optionally include a handle 284 for positioning and/or maneuvering curved plate 282 within space 160 to axially position curved plates 180, 182. As shown in FIG. 15, third curve plate 282 may interact on one axial side 286 thereof with one of curved plates 180, 182 (182 as shown). As shown in FIGS. 16D and 17D, third curve plate 282 may interact on an opposing axial side 288 thereof with any other (perhaps circumferentially extending) structure 290 within space 160 that may define a limiting detent for axial movement. Structure 290 may include, for example, circumferentially extending surfaces of an adjacent stage 165 or component segments 102 thereof.

With reference to FIGS. 16A-D, 17A-D, a method of separating first and second adjacent nozzle segments 124A-B (or component segments 102A-B) in (half) casing 150 of turbine system 100 will now be described. FIGS. 16A-D show various bottom views of tool 170 prior to separating first and second nozzle segments 124A-B, and FIGS. 17A-D show various views of tool 170 after separating first and second nozzle segments 124A-B.

FIG. 16A shows circumferentially positioning first and second curved plates 180, 182 of separation tool 170 along first and second adjacent nozzle segments 124A-B. First and second curved plates 180, 182 are in a first, retracted position in this setting, i.e., linear actuator 250 has first ends 184, 186 of curved plates 180, 182 close together if not touching one another. As noted, first curved plate 180 includes first end 184 for engaging portion 166 of first nozzle segment 124A and second end 222 coupled to base 172 of separation tool 170, i.e., by coupler 220. Further, second curved plate 182 includes first end 186 for engaging fixed element 188 of second nozzle segment 124B or half casing 150H and second end 252 coupled to base 172 by linear actuator 250. For purposes of description, in FIGS. 16A-D and 17A-D, fixed element 188 is shown as portion 168 of second nozzle segment 124B. In FIGS. 16A, first and second curved plates 180, 182 are positioned axially out of engagement with nozzle segments 124A, 124B so they can move circumferentially within space 160 to desired location.

FIGS. 16B-D show axially positioning first ends 184, 186 of first and second curved plates 180, 182 between portion 166 of first nozzle segment 124A and fixed element 188, regardless of the latter's form. First and second curved plates 180, 182 remain in the first, retracted position in this setting. Once in a circumferential position where first ends 184, 186 of first and second curved plates 180, 182 can be circumferentially positioned between portion 166 of first nozzle segment 124A and fixed element 188, curved plates 180, 182 can be moved axially to position first ends 184, 186 circumferentially between portion 166 of first nozzle segment 124A and fixed element 188. As shown in FIGS. 16D, axial spacer member 280 may be optionally used where curved plates 180, 182 may need additional axial positioning than otherwise available, e.g., by manual manipulation by a user, within space 160 to remain between portion 166 of first component segment 102A (nozzle segment 124A) and fixed element 188 (portion 168 of second component segment 102B (nozzle segment 124B) (shown) or portion 194 (FIG. 9) of half casing 150H)). Curved plate 282 of axial spacer member 280 axially positions (and holds) first and second curved plates 180, 182 in an operative position in stage 165 of turbine section 116 (FIGS. 1-2) with first ends 184, 186 of first and second curved plates 180,182 between portion 166 of first component segment 102A and fixed element 188. A single operator can perform the two positioning steps of tool 170 as described herein.

FIGS. 17A-D show activating linear actuator 250 to move first and second plates 180, 182 relative to one another between the first, retracted position (FIGS. 16B-D) in which first ends 184, 186 of first and second curved plates 180, 182 are retracted, e.g., close together if not touching, and a second, extended position in which first ends 184, 186 of first and second curved plates 180, 182 are distanced from one another to force (see force F) first and second nozzle segments 124A, 124B to separate. In the arrangement shown, first curved plate 180 acts as a pulling member on first component segment 102A (nozzle segment 124A) from second component segment 102B (nozzle segment 124B) to separate first component segment 102A from, for example, second component segment 102B and/or support structure 156. Similarly, second curved plate 182 acts as a pushing member on fixed element 188 to separate first component segment 102A, as described. FIGS. 17A-D show nozzle segments 124A, 124B (component segments 102A-B) having a circumferential space 300 therebetween. In the arrangement illustrated, linear actuator 250 is extended to apply force F to linearly move first ends 184, 186 of first and second curved plates 180, 182 apart from one another. As noted, first curved plate 180 and second curved plate 182 may slide in contact with one another along at least part of a length (L1, L2 (FIG. 6)) thereof as linear actuator 250 moves first and second curved plates 180, 182 relative to one another between retracted and extended positions. Linear actuator 250 can be extended in any manner dependent on its form, e.g., activating a hydraulic, pneumatic or electric ram, lengthening a turnbuckle, etc. Where axial spacer member 280 is used, as shown in FIG. 17D, curved plate 282 thereof axially holds first and second curved plates 180, 182 in the operative position with first ends 184, 186 of first and second curved plates 180, 182 between portion 166 of first component segment 102A and fixed element 188. Regardless of the form of linear actuator 250 used, a single operator can activate linear actuator 250 of tool 170 as described herein.

While first curved plate 180 has its first end 184 engaging portion 166 of first component segment 102A and second curved plate 182 has its first end 186 engaging fixed element 188, it will be recognized that the position of curved plates 180, 182 can be switched. That is, as explained relative to FIGS. 11 and 12, first and second curved plates 180, 182 can switch position and functions.

Embodiments of the disclosure provide various technical and commercial advantages, examples of which are discussed herein. For example, the tool applies a separation force in a safe manner apart from any sensitive structure, such as airfoils. In addition, the tool reduces the disassembly time required by not requiring access from outside the casing to operate and not requiring more than one operator. Further, the tool is highly customizable for applicability in different situations.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate+/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of the technology and to enable others of ordinary skill in the art to understand the disclosure for contemplating various modifications to the present embodiments, which may be suited to the particular use contemplated.

What is claimed is:

1. A tool for separating a first component segment from a second component segment adjacent the first component segment in a stage of a turbine section, the tool comprising:
a base;
a first curved plate including a first end configured to engage a portion of the first component segment;
a second curved plate including a first end configured to engage a fixed element, the fixed element including a portion of at least one of the second component segment and a half casing of the turbine section;
a coupler coupling a second end of one of the first and second curved plates to the base; and
a linear actuator between the base and a second end of the other one of the first and second curved plates,
wherein the linear actuator linearly moves the first and second curved plates relative to one another between a first position in which the first ends of the first and second curved plates are retracted and a second position in which the first ends of the first and second curved plates are extended a distance from one another to force the first and second component segments to separate.

2. The tool of claim 1, wherein the first and second component segments each include a nozzle segment, and the first and second curved plates have a radius of curvature matching a radius of curvature of a space between the casing and a radial outer surface of the nozzle segments at the stage of the turbine section.

3. The tool of claim 1, wherein the linear actuator includes a hydraulic ram.

4. The tool of claim 1, further comprising an axial spacer member including a third curved plate having an axial width configured to hold the first and second curved plates in an operative position in the stage of the turbine section with the first ends of the first and second curved plates between the portion of the first component segment and the fixed element.

5. The tool of claim 1, wherein the other one of the first and second curved plates has a first circumferential portion including the second end thereof, a second circumferential portion including the first end thereof, and an axial-extending portion coupling the first and second circumferential portions.

6. The tool of claim 1, wherein each of the first and second curved plates include a circumferential-extending portion and a perpendicular portion extending perpendicular to the circumferential-extending portion, wherein the first end of the first and second curved plates is located on the perpendicular portion thereof.

7. The tool of claim 6, wherein the perpendicular portion extends in an axial direction relative to an axis of the turbine section.

8. The tool of claim 6, wherein the perpendicular portion extends in a radially inward direction relative to an axis of the turbine section.

9. The tool of claim 1, wherein the coupler includes a body, a first connector at a first end of the body pivotally coupling the body to the base, and a second connector at a second, opposite end of the body pivotally coupling the body to the second end of the one of the first and second curved plates.

10. The tool of claim 9, wherein the body is a length-adjustable.

11. The tool of claim 9, wherein the linear actuator includes at least one of a first connector at a first end thereof fixedly coupling the linear actuator to the base and a second connector at a second, opposite end thereof fixedly coupling the linear actuator to the second end of the other one of the first and second curved plates.

12. The tool of claim 1, wherein the first and second curved plates include a radially-inward facing surface and a radially-outward facing surface, and further comprising at least one radial spacer on the radially-outward facing surface configured to position the respective curved plate in a radial position with the first end thereof between the portion of the first component segment and the fixed element.

13. The tool of claim 1, further comprising a fixing member configured to lock a position of the second component segment relative to the casing.

14. The tool of claim 1, wherein the first curved plate and the second curved plate slide in contact with one another along at least part of a length thereof as the linear actuator moves the first and second curved plates relative to one another between the first position and the second position.

15. A tool for separating a first nozzle segment from a second nozzle segment adjacent the first nozzle segment in a stage of a turbine section, the tool comprising:
a base;
a first curved plate including a first end configured to engage a portion of the first nozzle segment;
a second curved plate including a first end configured to engage a fixed element, the fixed element including a portion of at least one of the second nozzle segment and a half casing of the turbine section;
a coupler coupling a second end of one of the first and second curved plates to the base; and
a linear actuator between the base and a second end of the other one of the first and second curved plates,
wherein the linear actuator linearly moves the first and second curved plates relative to one another between a first position in which the first ends of the first and second curved plates are retracted and a second position in which the first ends of the first and second curved plates are extended a distance from one another to force the first and second nozzle segments to separate.
